(19) United States
(12) Patent Application Publication
(10) Pub. No.: US 2005/0275271 A1
(43) Pub. Date: Dec. 15, 2005

(54) Bracket for mounting either a fixed or a pivoting armrest

(76) Inventor: Richard Magnuson, Kentwood, MI (US)

Correspondence Address: CLARK & BRODY, 1090 VERMONT AVENUE, NW, SUITE 250, WASHINGTON, DC, 20005, US

(21) Appl. No.: 10/028,371

(22) Filed: Dec. 28, 2001

Related U.S. Application Data
(60) Provisional application No. 60/259,225, filed on Jan. 3, 2001.

(51) Int. Cl. B60N 2/46

(52) U.S. Cl. 297/411.38; 297/411.32

(57) ABSTRACT

A bracket for an armrest is capable of mounting the armrest for alternative conditions. In one of the conditions the armrest may pivot, while in a second of the conditions, the armrest is fixed.

### CROSS REFERENCE TO RELATED APPLICATIONS

This application claims the benefit of provisional application 60/259,225, filed on Jan. 3, 2001.

### TECHNICAL FIELD

This invention relates to the art of seat construction. In particular the invention relates to an armrest bracket for seats used in mass transit vehicles.

### BACKGROUND ART

It is common in the art of vehicle seats to provide an armrest between adjacent individual seats as well as at the ends of the seat. For example, a vehicle seat having two seating locations will typically have an armrest at the aisle, between the seating locations, and adjacent the window of the vehicle. The aisle and center armrests are usually mounted for pivotal movement to accommodate movement of the passengers, while the window armrest is typically fixed.

A problem faced in the assembly of these seats is that the brackets used for mounting the armrests at the several locations differ from each other. This means that the supplier must ensure that the correct number of brackets of each type is supplied, which complicates the inventory for a job. As well, assembly is complicated because the assembler must be careful to select the correct bracket for each location during assembly.

### SUMMARY OF THE INVENTION

In accordance with the invention, an armrest bracket is configured such that it can mount an armrest either to be capable of pivoting or held in a fixed orientation. Further, the bracket can be used on seats on the left or right side of a vehicle.

A mounting bracket in accordance with the invention provides a body portion with a head portion at one end that accepts an armrest in a first manner that allows the armrest to pivot or an alternative manner whereby the armrest is fixed. A foot portion at the opposite end of the body portion attaches either to a seat on either the left or right side of the vehicle. As well, the bracket accepts a cable that may be used to control the orientation of the seatback, as for reclining and the like.

The head portion is preferably cylindrical and includes a first axial element for mounting the armrest. This first axial element is used to mount the armrest for both the pivoting and the fixed modes. In the preferred embodiment, the first mounting element is a hole located on the cylindrical axis for receiving a mounting bolt for the armrest, but it may also be a shaft, a pin or another element that provides an axially located mount.

The head portion also includes two alternative mounting elements for cooperating with the first mounting element to provide alternative mountings. A first-alternative mounting element provides a fixed mounting location for the armrest that cooperates with the first mounting element to hold the armrest in a fixed orientation. A second-alternative mounting element provides pivotal movement of the armrest about the first mounting element. The pivotal motion is limited to a defined range, thus allowing the armrest to pivot out of the way to allow passengers easily to enter or leave the seat. In the preferred embodiment, the first-alternative mounting is an opening for receiving a mounting bolt, and the second-alternative mounting element is a curved slot that is concentric with the first mounting element. The curved slot receives a second mounting bolt.

The foot is designed to cooperate with the seat frame and, in the preferred embodiment, is u-shaped to provide a slot that receives an upstanding plate. The foot has holes for receiving bolts that pass through the plate for securing the foot to the plate in either of two possible orientations. In a first orientation the armrest can be mounted for the pivotal motion, and in a second orientation the armrest can be mounted in a fixed orientation.

### BRIEF DESCRIPTION OF THE DRAWINGS

FIG. 1 is an exploded perspective view of a preferred embodiment of the invention in an orientation for mounting an armrest for pivoting.

FIG. 2 is an exploded perspective view of a preferred embodiment of the invention in an orientation for mounting an armrest in a fixed position.

### DETAILED DESCRIPTION OF THE PREFERRED EMBODIMENT

With reference to the drawing figures, the invention comprises a bracket 2 for mounting an armrest 4. The bracket 2 includes a foot portion 6, a body portion 8, and a head portion 10. The bracket may made be constructed in any of several ways, and in the preferred embodiment, it is made of two stamped or cast metal parts that are mirror images of each other and secured to each other about a vertical mid-plane. The interior of the bracket is hollow for receiving a seat-control cable, as will be described further below.

The foot portion 6 has two depending parts 12 and 14 that form a slot 16 between them for receiving a mounting plate on a seat frame (not illustrated). Boltholes 18 receive mounting bolts 20 that pass also through holes in the mounting plate to secure the bracket to the seat frame.

Body portion 8 extends upward from the foot portion 6 by a distance determined by several factors, including the vertical dimension of the seat and the desired height of the armrest. The head portion 10 at the top of the body portion is configured to mount the armrest, such as that shown at 4. The head portion 10 is preferably cylindrical and includes an axially located opening 22 for receiving a bolt 24, which in turn passes though an opening 26 in the armrest. This provides a first mounting position for the armrest on the bracket.

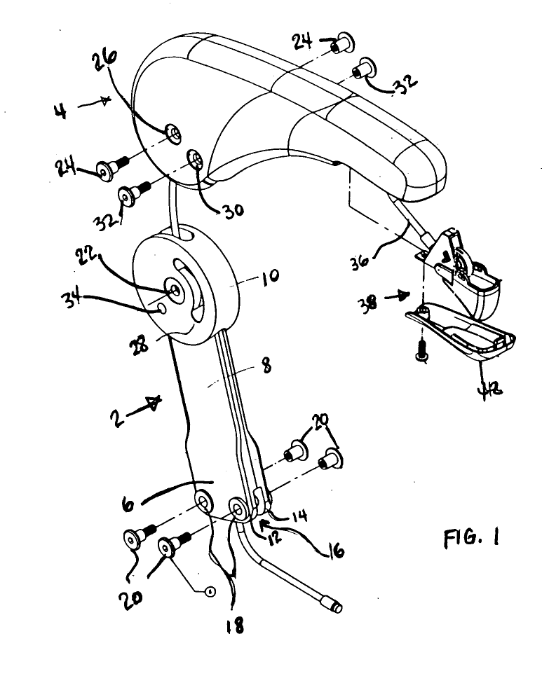

With particular reference to FIG. 1, the head also includes a curved slot 28 that is concentric with hole 22 for mounting the armrest for pivotal movement about the axis formed by the hole 22. The angular extent of the slot defines the extent of pivotal motion of the armrest. The armrest is provided with a hole 30 for receiving a bolt 32, which passes also through the slot 28.

It will be appreciated from FIG. 1 that the bolts 24 and 32 in cooperation with the hole 22 and the slot 28 mount the armrest 4 for pivotal motion about the axis formed by the hole 22.

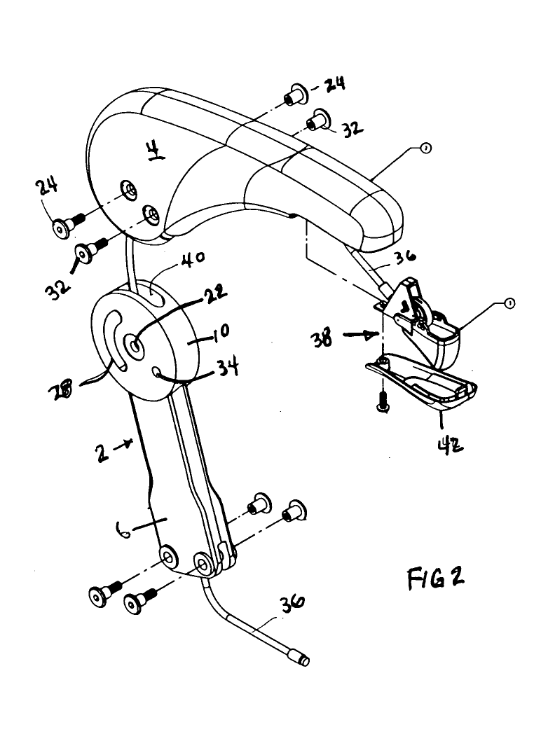

Referring now to FIG. 2, the bracket 2 is shown in an orientation for mounting the armrest in a fixed orientation. Thus, the bolts 24 and 32 pass through holes 22 and 34, respectively, for mounting the armrest 4 in a fixed orientation. It will be appreciated from a comparison of FIGS. 1 and 2 that the bracket 2 can be placed in the orientation for mounting the armrest pivotally or the orientation for mounting the armrest fixed by simply rotating the bracket about the longitudinal axis of the bracket. Thus, when the armrest is fixed, the slot 28 is not used, and when the armrest is mounted for pivoting, the hole 34 is not used.

It will further be appreciated that the mounting elements may be other than the illustrated bolts and holes. For example, the armrest could be mounted on the bracket by pins or other elements that provide the pivotal connection at the pivotal axis provided by hole 22 in the preferred embodiment and the curved or fixed connection formed by the slot 28 and the hole 34.

The armrest is configured also to accept a control cable 36 for controlling, for example, the orientation of the seat back. The upper end of the cable 36 is connected to a known control lever 38 that is positioned on the bottom of the remote end of the armrest and secured by a bezel 42. Preferably, the control lever 38 is positioned such that the occupant of the seat easily operates it. The cable 36 passes through a channel (not illustrated) in the armrest and into a hollow channel in the bracket by passing through elongate opening 40 in the head 10 of the bracket. The angular extent of the elongate opening 40 is enough to accommodate the pivotal motion of the armrest to avoid kinking the cable as the armrest is moved. The cable emerges from the lower part of the channel in the bracket into the unshaped slot 16. The cable can then be directed through the slot above the mounting plate, which is not illustrated, to the appropriate control mechanism in the chair.

It will be appreciated that a unique bracket has been described and that modifications within the scope of the appended claims will be apparent to those of skill in the art.

1. A bracket comprising a foot portion, a head portion, and a body portion connecting said foot and head portions, wherein said head portion comprises means for mounting an armrest in a selected one of a pivotal or a non-pivotal condition.

2. A bracket according to claim 1 wherein said head portion includes a first hole for receiving a first bolt to secure said armrest to said bracket in either said pivotal or non-pivotal conditions, a second hole for receiving a second bolt to secure said armrest in said non-pivotal condition, and a slot for receiving said second bolt alternatively to secure said armrest in said pivotal condition.

3. A bracket according to claim 2 having a channel formed therein configured to receive a cable.

4. A bracket according to claim 2 wherein said foot is symmetrical about a longitudinal axis of said bracket.

5. A bracket according to claim 2 wherein said head portion is cylindrical.
